(19) United States
(12) Patent Application Publication
(10) Pub. No.: US 2013/0290044 A1
(43) Pub. Date: Oct. 31, 2013

(54) SYSTEMS AND METHODS FOR PROVIDING A MARKETPLACE FOR SPACE RENTAL

(71) Applicants: George Stephen Webb, Shoreline, WA (US); Ryan Richard Hamlin, Redmond, WA (US)

(72) Inventors: George Stephen Webb, Shoreline, WA (US); Ryan Richard Hamlin, Redmond, WA (US)

(73) Assignee: PLACEFULL, INC., Seattle, WA (US)

(21) Appl. No.: 13/924,148

(22) Filed: Jun. 21, 2013

Related U.S. Application Data
(62) Division of application No. 13/343,637, filed on Jan. 4, 2012.

(51) Int. Cl. G06Q 10/02

(52) U.S. Cl. CPC G06Q 10/02
USPC 705/5

(57) ABSTRACT

Systems and methods for providing a space rental marketplace are provided. In some embodiments, space providers list spaces available for rent with a space management system. Each space may be associated with one or more activities to be performed during the rental. Each type of activity may include pre-activity, during-activity, and/or post-activity services that may be scheduled through the space management system at the time of scheduling the rental. Space providers may add new types of activities to the space management system to be associated with their rental space. Recurring rentals may be scheduled. In some embodiments, the space management system automatically ensures that complex scheduling requirements, such as predetermined amounts of certain types of renters, may be fulfilled.

### CROSS-REFERENCE TO RELATED APPLICATION

This application is a division of U.S. patent application Ser. No. 13/343637, filed Jan. 4, 2012, the entire disclosure of which is hereby incorporated by reference herein.

### BACKGROUND

Today, school districts, churches, universities, and other property managers have spaces that sit unused for large portions of every day. Though some of those spaces are currently offered for rent, for a renter to schedule such a rental usually requires contacting space providers individually to determine rental availability, activities for which the space may be used or configured, services provided along with the space rental, and/or the like. What is needed are systems and methods that facilitate matching of space providers with renters to help increase utilization of unused spaces.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a non-transitory computer-readable medium having computer-executable instructions stored thereon is provided. The computer-executable instructions, in response to execution by one or more processors of a computing device, cause the computing device to perform actions for scheduling space rentals. The actions comprise, in response to receiving a request from an end user to reserve a space during a first time period: determining an amount to be charged to the end user for reserving the selected space; using one or more payment providers to fulfill a payment from the end user of the determined amount; and creating a first record indicating that the space has been reserved by the end user during the first time period. The actions further comprise, in response to receiving a request from an administrative user to reserve the space during a second time period: creating a second record indicating that the space is reserved by the administrative user during the second time period; wherein the second record is created without fulfilling a payment from the administrative user.

In some embodiments, a computer-implemented method of scheduling space rentals is provided. In response to receiving, by a computing device, a request from an end user to reserve a space during a first time period: the computing device determines an amount to be charged to the end user for reserving the selected space; one or more payment providers are used to fulfill a payment from the end user of the determined amount; and the computing device creates a first record indicating that the space has been reserved by the end user during the first time period. In response to receiving, by the computing device, a request from an administrative user to reserve the space during a second time period: the computing device creates a second record indicating that the space is reserved by the administrative user during the second time period; wherein the second record is created without fulfilling a payment from the administrative user.

In some embodiments, a computing system is provided that comprises at least one processor and a computer-readable medium. The computer-readable medium has computer-executable instructions stored thereon that, in response to execution by the at least one processor, cause the computing system to perform actions for scheduling space rentals. The actions comprise, in response to receiving a request from an end user to reserve a space during a first time period: determining an amount to be charged to the end user for reserving the selected space; using one or more payment providers to fulfill a payment from the end user of the determined amount; and creating a first record indicating that the space has been reserved by the end user during the first time period. The actions further comprise, in response to receiving a request from an administrative user to reserve the space during a second time period: creating a second record indicating that the space is reserved by the administrative user during the second time period; wherein the second record is created without fulfilling a payment from the administrative user.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an overview of one embodiment of a space management system according to various aspects of the present disclosure;

FIG. 2 is a block diagram that illustrates further details of one embodiment of a space management system according to various aspects of the present disclosure;

FIGS. 3A-3C are a flowchart that illustrates one embodiment of a method of adding a space for rental to a space management system according to various aspects of the present disclosure;

FIGS. 4A-4B are a flowchart that illustrates one embodiment of a method of booking a space managed by a space management system according to various aspects of the present disclosure;

FIG. 5 illustrates an exemplary embodiment of a query interface generated by the end user interface engine to accept queries from end users, according to various aspects of the present disclosure;

FIG. 6 illustrates an exemplary embodiment of a search results interface by which an end user may view search results and specify a selection of a space, according to various aspects of the present disclosure;

FIG. 7 illustrates an exemplary embodiment of a space detail interface for displaying further details related to a selected space, according to various aspects of the present disclosure;

FIG. 8 illustrates an exemplary embodiment of a shopping cart interface according to various aspects of the present disclosure;

FIG. 9 illustrates an exemplary embodiment of a purchase confirmation interface generated according to various aspects of the present disclosure;

FIG. 10 illustrates an exemplary embodiment of a space management home interface generated by the provider interface engine according to various aspects of the present disclosure;

FIG. 11 illustrates an exemplary embodiment of a calendar bulk edit interface generated by the provider interface engine according to various aspects of the present disclosure;

FIG. 12 illustrates an exemplary embodiment of a space management interface generated by the provider interface engine according to various aspects of the present disclosure;

FIG. 13 illustrates an exemplary space detail management interface according to various aspects of the present disclosure;

FIG. 14 illustrates an exemplary embodiment of a space detail management interface configured to allow a space provider to manage further information associated with a space according to various aspects of the present disclosure; and

FIG. 15 illustrates aspects of an exemplary computing device appropriate for use with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

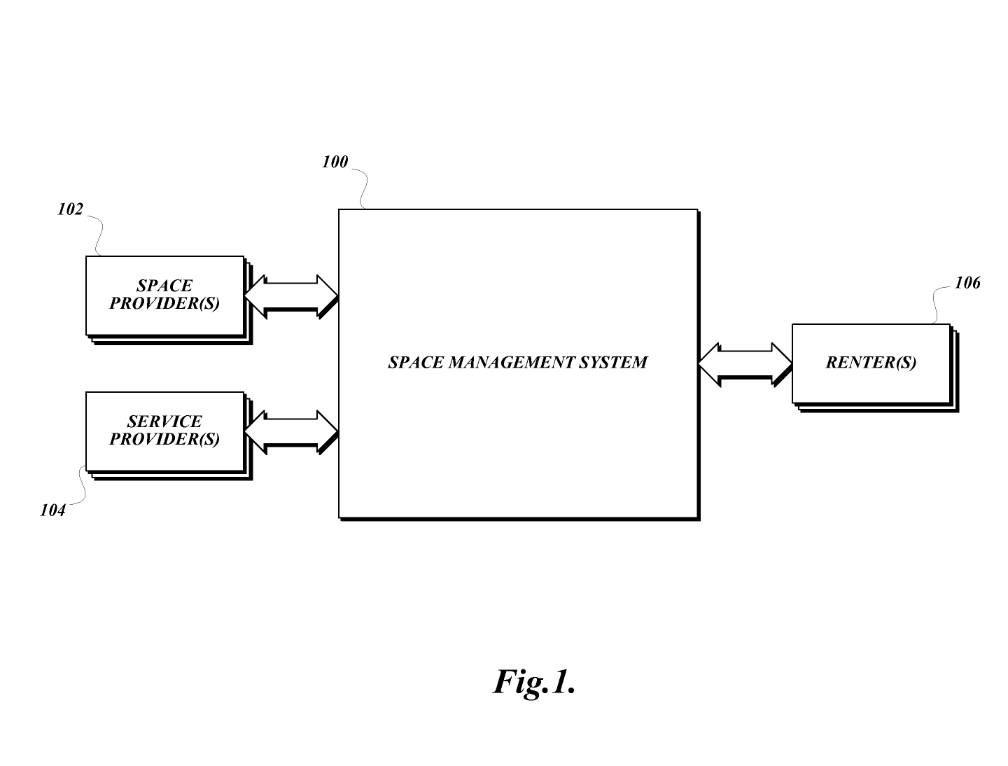

FIG. 1 is a block diagram illustrating an overview of one embodiment of a space management system according to various aspects of the present disclosure. A space management system 100 is provided, and is accessed by renters 106, space providers 102, and service providers 104. Space providers 102 access the space management system 100 to list spaces available for rent, activities for which the spaces are configured, restrictions for use of the spaces, and/or the like as described further below. Renters 106 access the space management system 100 to search the spaces available for rent, such as by location, activities provided, availability, and/or the like. Once a renter 106 chooses a space, the renter 106 may reserve the space using the space management system 100, which also handles scheduling, charging for use, and/or the like. Service providers 104 may also access the space management system 100 to list services associated with space rentals. One nonlimiting example of a service provider 104 may be a caterer who provides food and beverage services for space rentals. Another nonlimiting example of a service provider 104 may be a referee who offers officiating services for basketball court rentals. The renter 106 may also use the space management system 100 to find and schedule such services from service providers 104 to go along with the space rental.

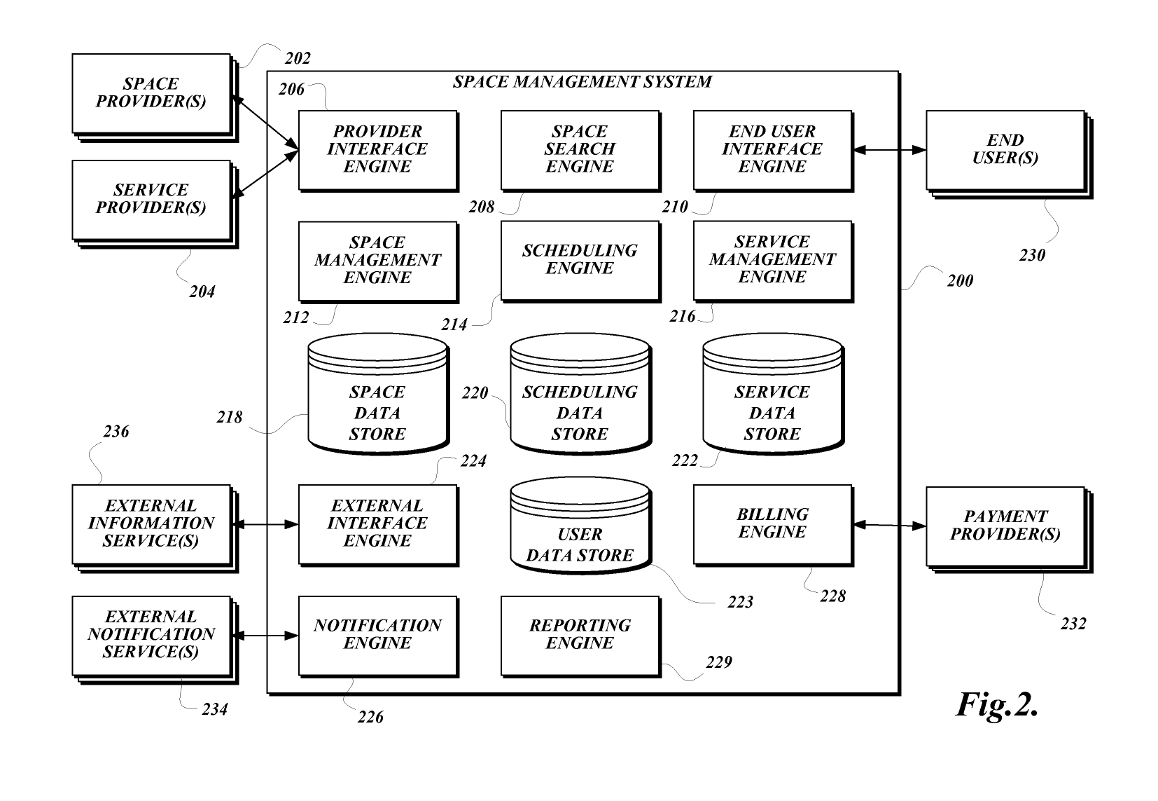

FIG. 2 is a block diagram that illustrates further details of one embodiment of a space management system 200 according to various aspects of the present disclosure. In some embodiments, the space management system 200 is configured to provide a plurality of engines and a plurality of data stores.

In general, the word “engine” (used interchangeably with the word “application”), as used herein, refers to logic embodied in hardware or software instructions, which can be written in a programming language, such as C, C++, COBOL, JAVA™, PHP, Perl, HTML, CSS, JavaScript, VBScript, ASPX, Microsoft.NET™ languages such as C#, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub engines. The engines or applications can be stored in any type of computer-readable medium or computer storage device and be stored on and executed by one or more general purpose computers, thus creating a special purpose computer configured to provide the engine or application.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 1508, as described further below. One of ordinary skill in the art will recognize that separate data stores described herein may be combined into a single data store, and/or a single data store described herein may be separated into multiple data stores, without departing from the scope of the present disclosure.

The engines may include a provider interface engine 206, a space search engine 208, an end user interface engine 210, a space management engine 212, a scheduling engine 214, a service management engine 216, an external interface engine 224, a notification engine 226, a billing engine 228, and a reporting engine 229. In some embodiments, the space management engine 212 is configured to provide functionality for adding and removing spaces from the space management system 200. The space management engine 212 may also be configured to provide functionality for allowing a space provider 202 to edit information relating to one or more spaces managed by the space management system 200, such as activity type availability, conditions of use, associated service providers 204, required services before and/or after scheduling an activity of a particular type, and/or other information related to scheduling rental of the space. In some embodiments, the service management engine 216 is configured to provide similar functionality for allowing a service provider 204 to add, remove, or edit information relating to services offered by the service provider 204 that are schedulable in association with space rentals through the space management system 200.

In some embodiments, the space search engine 208 is configured to provide functionality to allow end users 230 to search the spaces and services managed by the space management system 200 for a space suitable for a desired purpose. The space search engine 208 may allow the end users 230 to search for spaces based on any information stored by the space management system 200. For example, in some embodiments, the space search engine 208 may allow the end users to search spaces by name, by location, by type of space, by activities available, by schedule availability, by services available, by usage restrictions, and/or by any other information available to the space management system 200. Though the name of the space search engine 208 refers to “spaces,” in some embodiments the space search engine 208 is also configured to provide similar search functionality for services. In some embodiments, searches for services are provided by a separate search engine (not pictured).

In some embodiments, the scheduling engine 214 is configured to provide functionality related to scheduling of space rentals. In some embodiments, the scheduling engine 214 may present information regarding availability of a given space, and may store a rental record for a given space to indicate that the given space has been reserved for rental at a given time. In some embodiments, the scheduling engine 214 may work with the space search engine 208 to find spaces that are available at a predetermined time or for a predetermined schedule.

In some embodiments, the scheduling engine 214 supports recurring rentals, such that the scheduling engine 214 may be configured to create two or more rentals on different days. For example, the scheduling engine 214 may be configured to create a rental on a given day of the week for a given number of weeks, and/or until a given end date. In some embodiments, the scheduling engine 214 may be configured to handle exceptions to a recurring rental request. For example, a renter may submit a recurring rental request for a given space that includes a request for four repeated rentals on Tuesday nights at 8:00 PM. The scheduling engine 214 may detect that the given space is available for each requested Tuesday night except for the second instance, wherein the space has already been rented. The scheduling engine 214 may handle such a conflict in any suitable way. For example, in some embodiments, the scheduling engine 214 may create rental records for the three dates that do not conflict, and may display an error to the renter for the conflicting date. As another example, in some embodiments, the scheduling engine 214 may suggest a different suitable space that is available on the conflicting day (or for all days in the recurring schedule). As yet another example, in some embodiments, the scheduling engine 214 may suggest a different time or day for the conflicting day (or for all days in the recurring schedule) during which the space is available.

In some embodiments, the end user interface engine 210 is configured to provide access to the other components of the space management system 200 to end users 230 such as potential renters, actual renters, and/or the like. In some embodiments, the end user interface engine 210 is configured to generate a web-based graphical user interface, with which the end users 230 interact via a typical web browser executing on a suitable computing device such as a desktop computer, laptop computer, tablet computer, smart phone, and/or the like. In some embodiments, the end user interface engine 210 is configured to provide an application programming interface (API) which provides programmatic access to the components of the space management system 200 to a graphical user interface generated by an application installed and executing on a computing device of the end user 230. For example, in some embodiments, the end user 230 may access the space management system 200 via an application installed on a smart phone, wherein the application generates a graphical user interface and communicates with the API provided by the end user interface engine 210 to access the space management system 200.

In some embodiments, the provider interface engine 206 is configured to provide access to the other components of the space management system 200 to space providers 202 and/or service providers 204. Similar to the end user interface engine 210, the provider interface engine 206 may be configured to generate a web-based graphical user interface to be accessed via a web browser, or may be configured to generate an application programming interface which provides programmatic access to the components of the space management system 200.

In some embodiments, the external interface engine 224, the notification engine 226, and the billing engine 228 are configured to communicate with third-party information services to provide additional functionality. In some embodiments, the external interface engine 224 is configured to communicate with one or more external information services 236 to obtain information not stored by the space management system 200. As a nonlimiting example, the external interface engine 224 may communicate with an external information service 236 that provides mapping information and/or location search services to help provide searches of spaces near a specified location. As another nonlimiting example, the external interface engine 224 may communicate with external information services 236 that store media describing or depicting managed spaces, such that storage space within the space management system 200 may be conserved.

In some embodiments, the notification engine 226 is configured to communicate with one or more external notification services 234 to transmit notifications to space providers 202, service providers 204, and end users 230. Notifications may include, but are not limited to, messages indicating that a space has been rented, messages indicating that a service has been scheduled, messages indicating that a rental has been confirmed, and/or the like. One example of an external notification service 234 may be a traditional email server, and the notification engine 226 may use the email server to transmit notifications. Another example of an external notification service 234 may be a traditional SMS system, and the notification engine 226 may use the SMS system to transmit text message notifications. The external notification services 234 described above are exemplary only, and any suitable service that may be used by the notification engine 226 to transmit messages to appropriate parties may be used. In some embodiments, the billing engine 228 is configured to communicate with one or more payment providers 232 to provide billing services for the space management system 200. For example, a space provider 202 or service provider 204 may set a particular fee for a space rental or a provided service. The space management system 200 may allow the end user 230 to pay the fee directly through the space management system 200. The billing engine 228 may use a payment provider 232 such as a credit card payment fulfillment service, PayPal, and/or the like to receive funds from the end user 230. The billing engine 228 may likewise use a payment provider 232 to transfer the funds from the end user 230 to payment accounts of the appropriate space provider 202 or service provider 204. In some embodiments, the billing engine 228 may be configured to transfer a portion of the funds from the end user 230 to an account associated with the space management system 200.

In some embodiments, the reporting engine 229 is configured to generate reports relating to rental history, revenue, and future scheduled rentals by space listing or space establishment. Once generated, reports may be presented to the space provider by any suitable method, such as viewing online, exported in a data format, printed to a hard copy, and/or the like. One nonlimiting example of a report may be a space history report.

The reporting engine 229 may be configured to generate space history reports based on a selected date range, and may report data relating to the rental history of an existing space (or multiple spaces) within the selected date range, an entire rental history for the existing space (or multiple spaces), and/or the like. Another nonlimiting example of a report may be a space revenue report. The space revenue report may show revenue information relating to a specific space rental. One of ordinary skill in the art will recognize that these reports are exemplary only, and that in some embodiments, the reporting engine 229 may be configured to generate other types of reports instead of or in addition to these reports.

In some embodiments, the space management system 200 also includes a space data store 218, a scheduling data store 220, a service data store 222, and a user data store 223. As discussed earlier, it is understood that the multiple data stores described herein, including the space data store 218, the scheduling data store 220, the service data store 222, and/or the user data store 223 may be combined in any combination into one or more single data stores, and/or a single data store described herein may be further separated into multiple data stores, without departing from the scope of the present disclosure. Accordingly, while various data stores are identified herein by different titles for ease of reference, the different titles do not require that the data stores be separately maintained.

In some embodiments, the user data store 223 may be configured to store information associated with users. The information associated with users may include, but is not limited to, login credentials, spaces a user has identified as favorites, user rental history, and/or the like. In some embodiments, space providers 202 may be able to identify particular users as space managers or as members of one or more groups. A user identified as a space manager may be given access to add or modify space information on the system, and/or to book a space through an administrative interface. A user may also be a member of a group independent of whether that user is a space manager. Each group may contain one or more space managers. For example, a user may be a member of a “Parks Department” group when booking space rental reservations at a park without being considered a space manager, but may also be considered a space manager for one or more other spaces.

In some embodiments, the space data store 218 is configured to store information associated with spaces made available by space providers 202 for rental by end users 230.

For example, for a given space, the space data store 218 may include a name, an address, a text description, an owner, a set of available activities, a set of space capabilities (such as maximum numbers of people for given activities, services available from the space provider 202 and/or affiliated service providers 204, and/or the like), a set of feedback received from end users 230 (such as reviews, ratings, and/or the like), a set of images depicting the space, a set of usage restrictions and/or agreements for using the space, and/or the like. The information in the space data store 218 may be updated by a space provider 202 through an interface provided by the provider interface engine 206.

In some embodiments, the space data store 218 may also be configured to store a plurality of activity definitions. An activity definition may describe an activity available at one or more spaces, and the set of available activities associated with the space may refer to the activity definitions. This may allow end users 230 to search for spaces that provide a particular activity. Further, storing activity definitions in the space data store 218 allows activities to be consistently defined across spaces, and for new activities to be defined dynamically. For example, the space data store 218 may include a disparate variety of activity definitions, such as for weddings, meetings, and concerts. If a space provider 202 has a gym that they would like to rent out for athletic activities, such as basketball practices, the space provider 202 may create a new activity definition for basketball practices to be associated with their space in the space management system 200. The variety of activities defined in the space management system 200 for association with a space rental may be entirely unrelated to one another in form, type, or substance, and are not limited by the specific examples discussed herein.

In some embodiments, activity definitions may also include a set of pre-activity, during-activity, and post-activity services associated with the activity. Some services may be provided by the space provider 202, and other services may be provided by service providers 204. Pre-activity services may be services that prepare the space for the associated activity, during-activity services may be services that are performed during the activity, and post-activity services may be services that return the space to a previous state. The services included in the activity definitions may include a description of the services, an amount of time the services should take, providers of the services, and/or the like. One example activity is a wedding. Pre-activity services for a wedding may include, but are not limited to, setting up tables and chairs, decorating the space, and/or the like. During-activity services for a wedding may include, but are not limited to, catering services, musician services, and/or the like. Post-activity services for a wedding may include, but are not limited to, breaking down tables and chairs, discarding decorations, cleaning, and/or the like. The services of setting up tables and chairs and breaking down tables and chairs may be indicated as provided by the space provider 202, while the catering services and musician services may be indicated as provided by third-party service providers 204, which may be any service provider 204 in the space management system 200 or may be limited to a pre-approved list.

Another example activity is a basketball game. Pre-activity services for a basketball game may include, but are not limited to, setting up basketball hoops, room dividers, benches for the teams, bleachers for fans, and/or the like. During-activity services for a basketball game may include, but are not limited to, officiating services, timekeeping services, scorekeeping services, and/or the like. Post-activity services for a basketball game may include, but are not limited to, cleaning, stowing the basketball hoops and equipment, and/or the like. The setup and stowing services may likely be provided by the space provider 202, while the officiating services, timekeeping services, and scorekeeping services may likely be provided by a third-party provider of officiating services.

Storing timing information for pre- and post-activity services may help the scheduling engine 214 ensure that adjacent rentals are associated with adequate set-up and clean-up time. For example, if a gymnasium is associated with a wedding activity and a basketball activity, the scheduling engine 214 should ensure that adequate time is available between the end of a basketball rental and a wedding rental to put the basketball hoops away, to mop the floor, and so on, before the service providers for the wedding need to start setting up tables and decorations.

In some embodiments, the activity definitions may include attributes of the activity other than timing that may nevertheless affect the scheduling of other activities in the space. For example, a grass field may be subject to different amounts of damage based on the type of activity performed. A rugby game, for instance, may be considered a high impact activity, whereas a soccer game may be considered a low impact activity.

The scheduling engine 214 may be configured to ensure that at least a week is placed between scheduled high-impact activities, whereas no scheduling restrictions may be placed on low-impact activities. As another example, chalk lines may be applied to a grass field as a pre-activity service for a soccer game activity. The scheduling data store 220 may cancel post-activity services involved with removing the chalk lines for a first soccer game that is immediately followed by a second soccer game, and may cancel the pre-activity services involved with applying the chalk lines for the second soccer game, thus allowing the two soccer games to be scheduled back-to-back. Meanwhile, if a rugby game activity was scheduled after the first soccer game, the pre- and post-activity services for both activities would remain, and the activities could not be scheduled as close to each other in time.

One of ordinary skill in the art will recognize that the above-described activities are exemplary only, and that other activities are contemplated within the scope of the present disclosure.

The service data store 222 is configured to store similar information associated with services made available by service providers 204 for purchase by end users 230. For example, for a given service provider, the service data store 222 may include a name, a business address, a text description, a set of services offered by the given service provider, a service area, and/or the like. The information in the service data store 222 may be updated by a service provider 204 through an interface provided by the provider interface engine 206.

The scheduling data store 220 includes availability information for spaces offered for rental by space providers 202 and for services offered by service providers 204. The information stored by the scheduling data store 220 is sufficient for the scheduling engine 214 to generate calendar information for each space and/or service, and to search for availability for spaces and services. In some embodiments, the scheduling data store 220 may store a reservation record for each space rental and scheduled service appointment that associates the space and/or service with the associated end user 230 at a given time and/or a recurring time. In some embodiments, a reservation record or rental record that associates a space or service with an end user 230 at a given time and/or a recurring time may be stored in the space data store 218 or service data store 222, and the scheduling data store 220 may simply store information indicating when the space or service is or is not available. One of ordinary skill in the art will recognize that the availability information may be stored in the scheduling data store and searched by the scheduling engine 214 using any suitable technique.

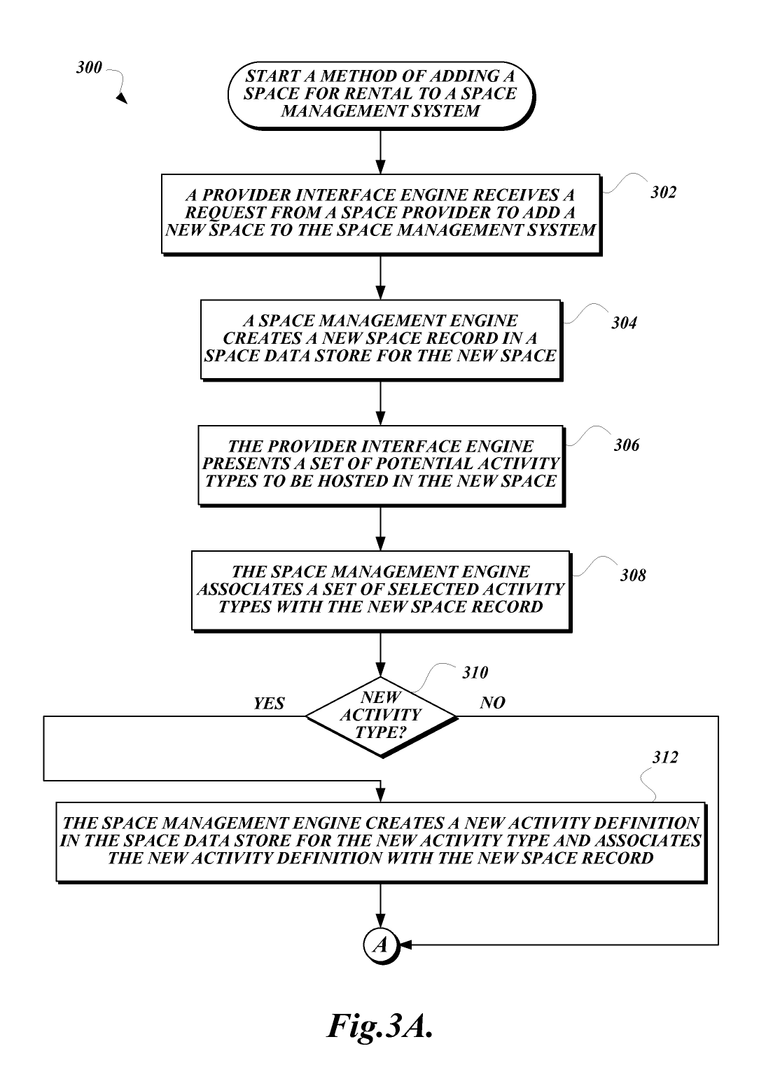

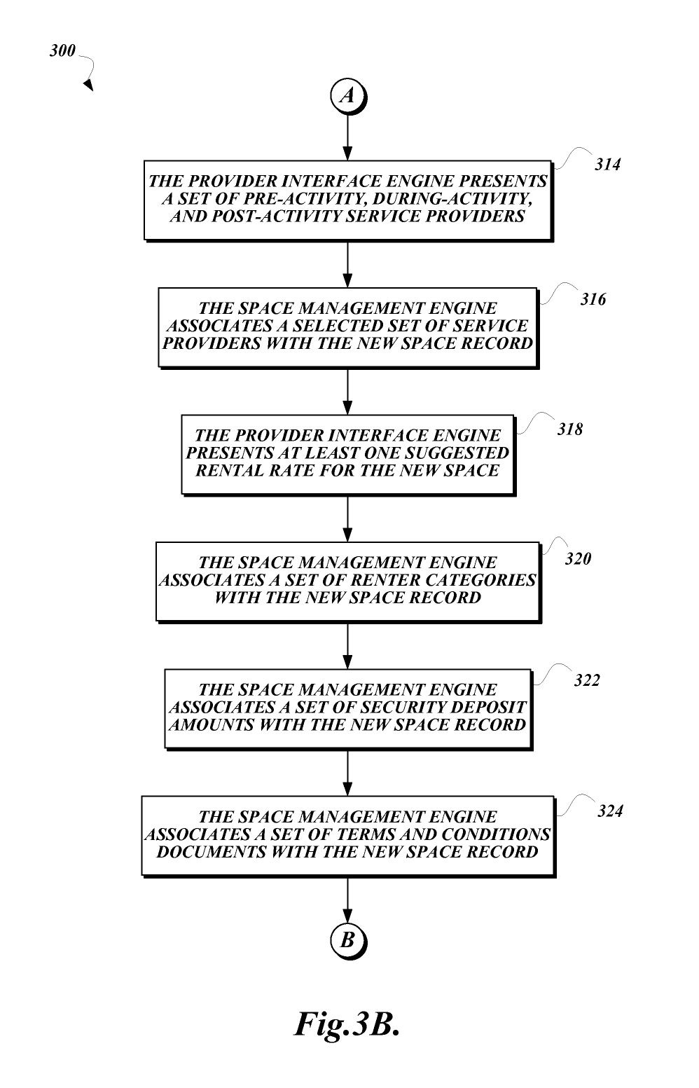

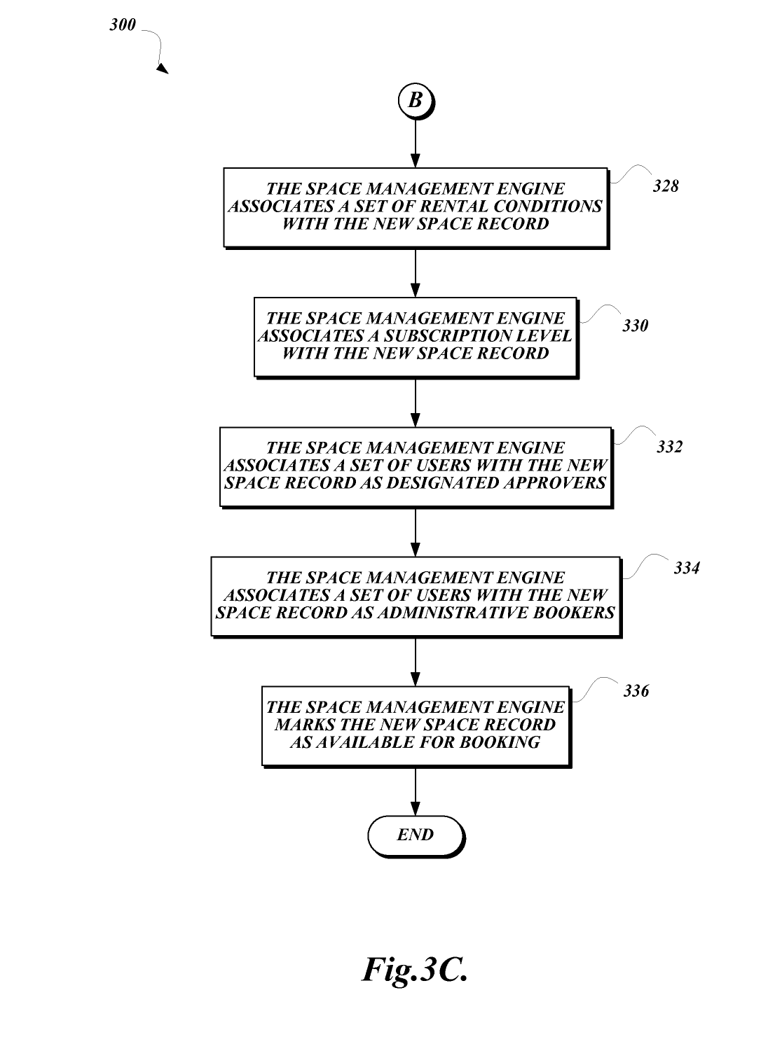

FIGS. 3A-3C are a flowchart that illustrates one embodiment of a method 300 of adding a space for rental to a space management system. From a start block

(FIG. 3A), the method 300 proceeds to block 302, where a provider interface engine 206 receives a request from a space provider 202 to add a new space to the space management system 200. In some embodiments, the request to add the new space may include information associated with the new space, including a name, a text description, a location, and/or the like. At block 304, a space management engine 212 creates a new space record in a space data store 218 for the new space. The space record may include the information associated with the new space from the request to add the new space.

At block 306, the provider interface engine 206 presents a set of potential activity types to be hosted in the new space. In some embodiments, the set of potential activity types may be retrieved from a set of activity definitions in the space data store 218. The space provider 202 may select a set of activity types from the set of potential activity types, and at block 308, the space management engine 212 associates the set of selected activity types with the new space record. In some embodiments, the set of selected activity types may be empty if the space provider 202 wants to list the new space as a generic space unassociated with any activities, or if none of the activity definitions stored by the space management system 200 are appropriate.

In some embodiments, the space management system 200 may provide the ability for space providers 202 to add new activity definitions to the system if none of the activity definitions stored by the space management system 200 are appropriate. At decision block 310, a test is performed to determine whether the addition of a new activity type has been requested. If the answer to the test at decision block 310 is YES, the method 300 proceeds to block 312, where the space management engine 212 creates a new activity definition in the space data store 218 for the new activity type, based on information included with the new activity type request, and associates the new activity definition with the new space record. The method 300 then proceeds to a continuation terminal (“terminal A”). If the answer to the test at decision block 310 is NO, the method 300 also proceeds to terminal A.

From terminal A (FIG. 3B), the method 300 proceeds to block 314, where the provider interface engine 206 presents a set of pre-activity, during-activity, and post-activity service providers 204 to the space provider 202. The service providers 204 are selected from the service data store 222 based on service providers 204 that indicate that they are available to provide services associated with at least one of the selected activity types. At block 316, the space management engine 212 associates a selected set of service providers 204 with the new space record. The selected set of service providers 204 may be empty, in which case any appropriate service provider 204 may be selected by an end user 230 while scheduling a rental. Otherwise, the service providers 204 in the selected set of service providers 204 may be used as a permitted or recommended set of service providers 204, and an end user 230 may be presented the set of service providers 204 while scheduling a rental. In some embodiments, service providers 204 from the set of service providers 204 may be automatically selected by the space management system 200 while an end user 230 is scheduling a rental, and the set of service providers 204 may not be presented to the end user 230.

At block 318, the provider interface engine 206 presents at least one suggested rental rate for the new space. The provider interface engine 206 may determine the suggested rental rate using any suitable method. In some embodiments, the provider interface engine 206 may find other spaces within a predetermined radius of the new space, and may present a range of rental rates offered by those spaces. In some embodiments, the provider interface engine 206 may filter the other spaces based on whether the other spaces provide similar activities. In some embodiments, the provider interface engine 206 may present comparable spaces and associated rates so that the provider of the new space may make an informed decision regarding comparable rates. In some embodiments, the space management system 200 may provide analysis of the comparable rates, along with automatic recommendations. As a nonlimiting example, in some embodiments, the space management system 200 may search the space data store 218 for existing spaces that are similar in nature to the new listing based on one or more attributes such as a category type, a location, common amenities or activities offered by the spaces, and/or the like. A suggested rental rate may be presented based on “like” properties in the area that match the considered attributes. The space provider 202 may then have an opportunity to accept the suggested price, or to edit the price as they see fit.

In some embodiments, a space provider 202 may be provided an option to specify more than one renter category for the space. For example, a space provider 202 may specify one renter category for for-profit or private renters, and another renter category for non-profit or public sector renters. Renters from the different renter categories may be given different consideration within the space management system 200. As one example, renter categories may be assigned different rental rates. As another example, renter categories may be provided different booking priorities, such that a renter from one category may be able to bump a renter from another category for a given time, or such that rental blocks are set aside for rental only by renters from a given prioritized category. At block 320, the space management engine 212 associates a set of renter categories with the new space record. In some embodiments, each renter category may include a rental rate. In some embodiments, each renter category may include booking priority information.

At block 322, the space management engine 212 associates a set of security deposit amounts with the new space record. In some embodiments, the space provider 202 may specify different security deposit amounts for each associated renter category. In some embodiments, the space provider 202 may specify different security deposit amounts for each available activity, in part to reflect different amounts of risk or damage involved with different types of activities. At block 324, the space management engine 324 associates a set of terms and conditions documents with the new space record. In some embodiments, the provider interface engine 206 may present default terms and conditions documents to the space provider 202 for selection. In some embodiments, the provider interface engine 206 may be configured to receive new terms and conditions documents drafted by the space provider 202. Next, the method 300 proceeds to a continuation terminal (“terminal B”).

From terminal B (FIG. 3C), the method 300 proceeds to block 328, where the space management engine 212 associates a set of rental conditions with the new space record. Rental conditions may include, but are not limited to, a maximum number of event attendees, age limits, a maximum or minimum number of reservations from a particular renter category during a specified period of time, whether alcohol is permitted, whether the event may be catered, whether government permits are required for a specific activity, and/or the like.

At block 330, the space management engine 212 associates a subscription level with the new space record. In some embodiments, the space management system 200 may provide one or more subscription levels for space providers 202. Different subscription levels may provide different functionality to the space providers 202. For example, a higher subscription level may provide more assistance in setting rental rates, may allow a greater number of activities to be associated with a single space, may allow spaces to be subdivided amongst several concurrent activities, may provide preferred placement in search results, and/or the like.

In some embodiments, rentals that are automatically scheduled by the space management system 200 may be scheduled pending approval of an approving user. At block 332, the space management engine 212 associates a set of users with the new space record as designated approvers. In some embodiments, user accounts may be stored in the space data store 218, in a user data store 223, in an external information service 236, and/or in any other suitable storage location.

It may be desirable for some space providers 202 to provide space reservation services outside of the space management system 200, such as via a preexisting telephone hotline provided by the space provider 202, a staffed reservation desk or marketing office, and/or the like. Similarly, the space provider 202 may wish to reserve a space for its own activities. For instance, a school providing a gymnasium for rent may wish to reserve the gymnasium for school assemblies, sporting events, and/or the like without having to pass through the end user interface. Accordingly, the space management system 200 may provide an administrative interface for agents of a space provider 202 to enter such reservations into the space management system 200. The administrative interface may allow the agents to bypass much of the verification performed and fees charged by the space management system 200. At block 334, the space management engine 200 may associate a set of users with the new space record as administrative bookers, who may schedule rentals without using the end user interface and may bypass certain protections or charges applied to end users 230.

At block 336, once the new space has been fully configured, the space management engine 212 marks the new space record as available for booking, and the space management system 200 will begin returning the new space in response to appropriate searches submitted by end users 230. The method 300 proceeds to an end block and terminates.

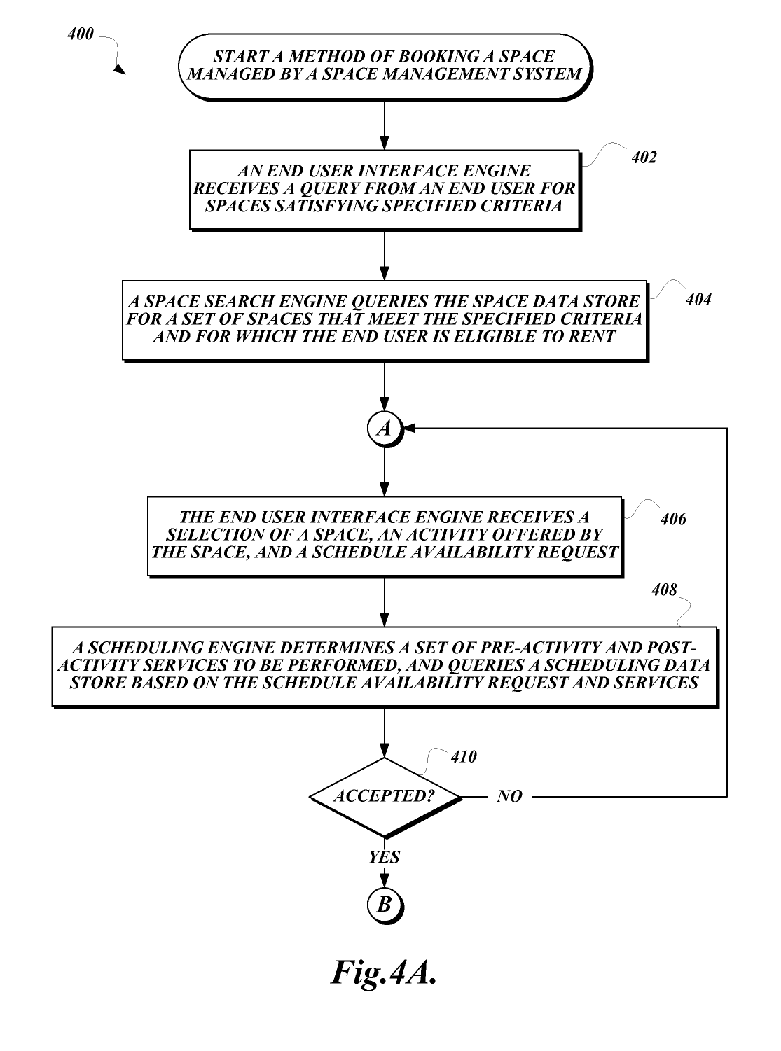

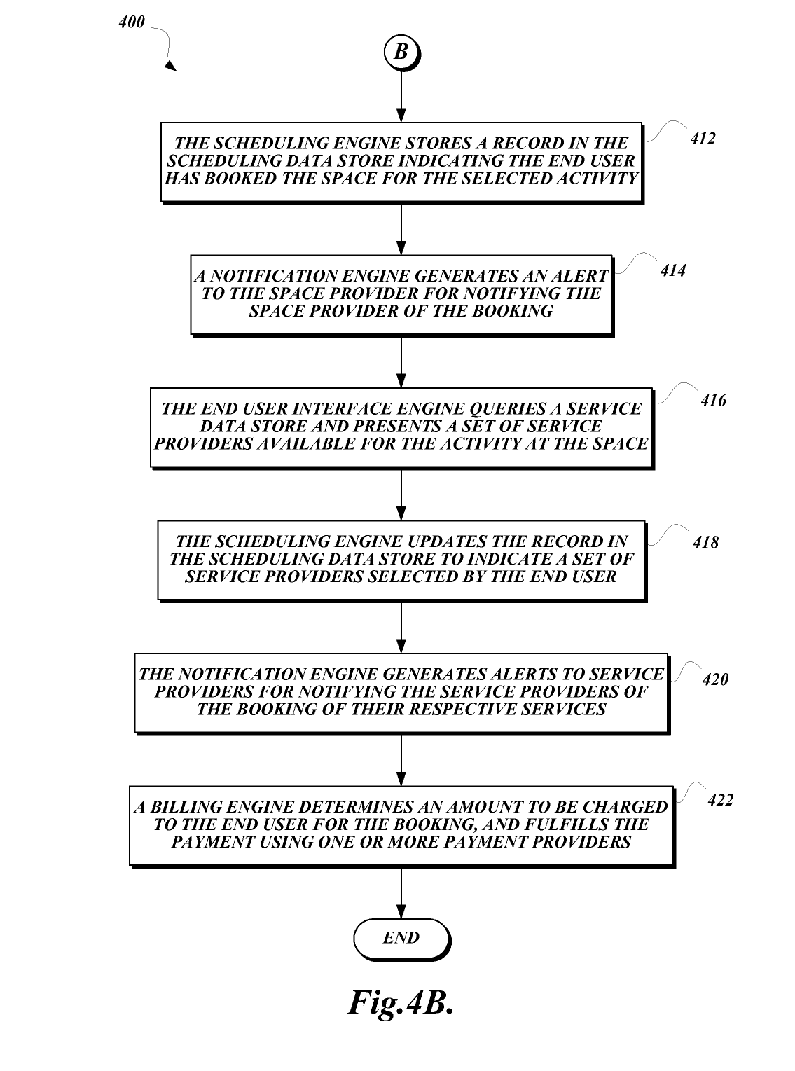

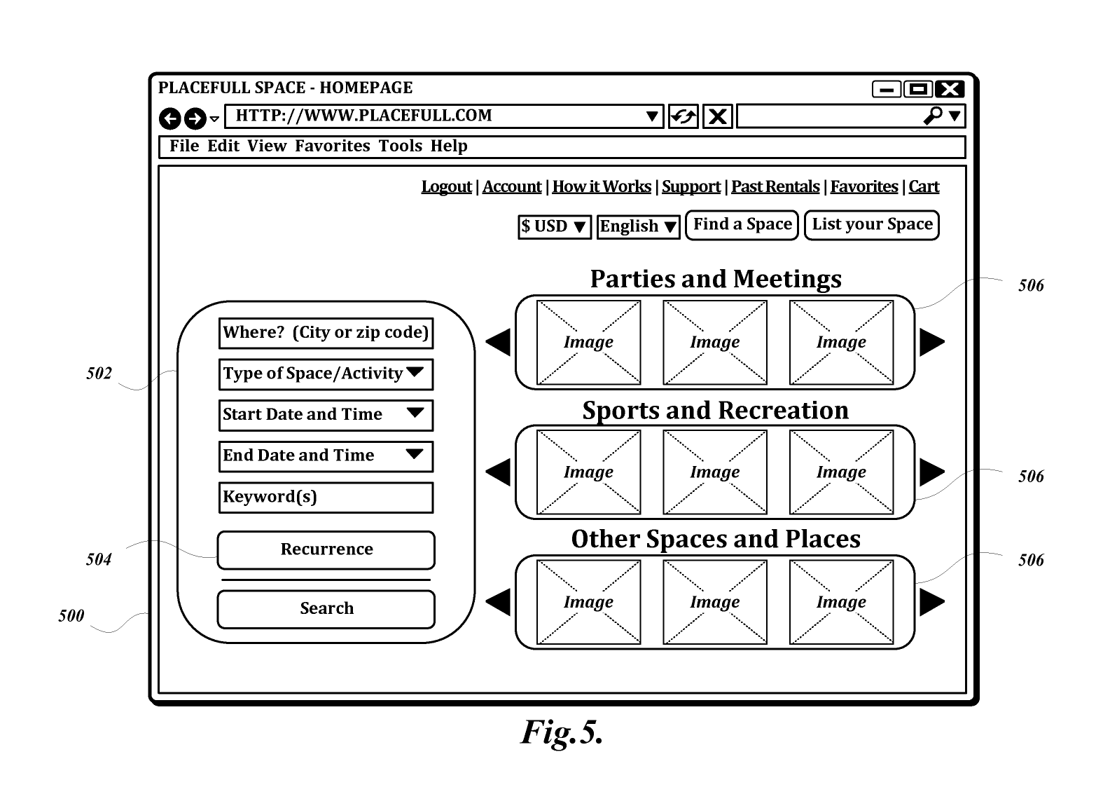

FIGS. 4A-4B are a flowchart that illustrates one embodiment of a method 400 of booking a space managed by a space management system 200 according to various aspects of the present disclosure. From a start block (FIG. 4A), the method 400 proceeds to block 402, where an end user interface engine 210 receives a query from an end user 230 for spaces satisfying specified criteria. The specified criteria may include any suitable information for locating a space, including, but not limited to, a location, a name, an activity offered, a rental cost, and/or the like. FIG. 5 illustrates an exemplary embodiment of a query interface 500 generated by the end user interface engine 210 to accept queries from end users 230, according to various aspects of the present disclosure. In some embodiments, the interface 500 may include a query parameters area 502. The query parameters area 502 may allow an end user 230 to specify query parameters such as a location, a type of space or activity available at the space, a start date and/or time for the rental, an end date and/or time for the rental, a set of keywords located in the name, description, or other data associated with the space, and/or the like. In some embodiments, one or more sets of images may be presented by the interface 500 before a search is submitted. The images may be associated with spaces near a location of the end user 230, may be associated with spaces of a given subscription level or having paid an advertising fee, and/or may be selected in any other suitable way.

A recurrence interface button 504 may cause an interface to be displayed to allow the end user 230 to specify one or more recurrence parameters for the search, such as recurring a given number of times at the same or similar time of day; on one or more specified days of the week, month, or year; and/or the like. The recurrence interface may allow the end user 230 to specify whether spaces should be returned only if all requested times are available at a single space, if all times may be reserved in more than one space within a given proximity of each other, and/or the like.

Returning to FIG. 4A, the method then proceeds to block 404, where a space search engine 208 queries the space data store 218 for a set of spaces that meet the specified criteria and for which the end user is eligible to rent 230. In some embodiments, the space management system 200 may determine that the end user 230 is part of a particular renter category. Some spaces may only be available to end users 230 in certain renter categories, such as non-profit users and/or the like, and so the space search engine 208 may filter out spaces unavailable to the end user 230 due to the user's renter category.

The method 400 then proceeds to a continuation terminal (“terminal A”), and then to block 406, where the end user interface engine 210 receives a selection of a space, an activity offered by the space, and a schedule availability request. In some embodiments, the schedule availability request may include a day, time, and duration for a single rental. In some embodiments, the schedule availability request may include recurrence information for a recurring rental, as discussed above. At block 408, a scheduling engine 214 determines a set of pre-activity and post-activity services to be performed based on the selected activity, and queries a scheduling data store 220 based on the schedule availability request and services. As discussed above, the scheduling engine 214 may include extra time before and after a requested time to allow for the pre-activity and post-activity services to be performed, and/or may ensure that a proposed activity does not run afoul of any other usage restrictions stored for the space.

In some embodiments, the schedule availability request may be included with the initial query at block 402, and a list of spaces returned by the space search engine 208 may only include spaces that are available during the time or times indicated by the schedule availability request and any associated pre-activity and post-activity services.

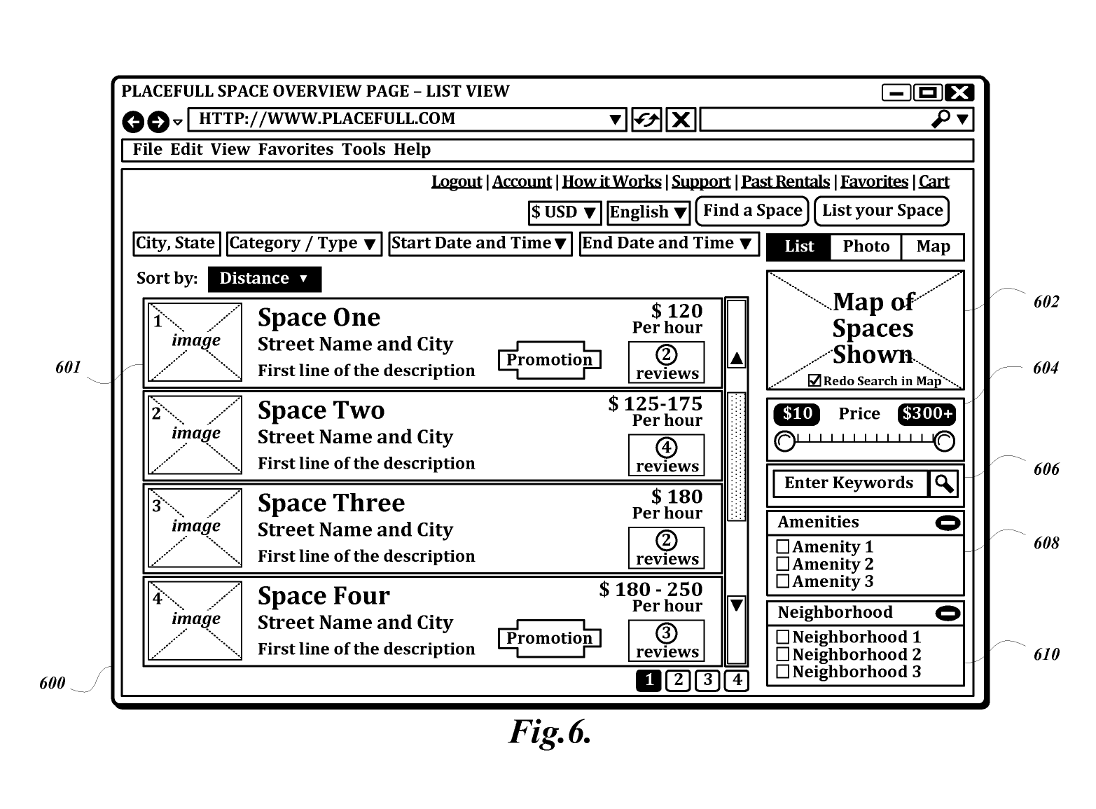

FIG. 6 illustrates an exemplary embodiment of a search results interface 600 by which an end user 230 may view search results and specify a selection of a space, according to various aspects of the present disclosure. In the illustrated interface 600, it may be assumed that the end user 230 specified a schedule availability request and an activity offered by the space along with the initial search request, and that each of the spaces displayed in the list of spaces 601 is available at the requested time for the requested activity. Each space in the list of spaces 601 includes information for identifying the space, an indicator of whether any special promotions are available for the space, an indication of whether any reviews of the space from other users are available, and an indication of the available rates. The rates displayed may be a range if different rates are available for different types of users, for different types of activities, and/or the like. In some embodiments, the interface 600 may also include one or more interface elements for refining the search, such as a map search filter 602, a price search filter 604, a keyword search filter 606, an available amenities filter 608, a neighborhood filter 610, and/or the like.

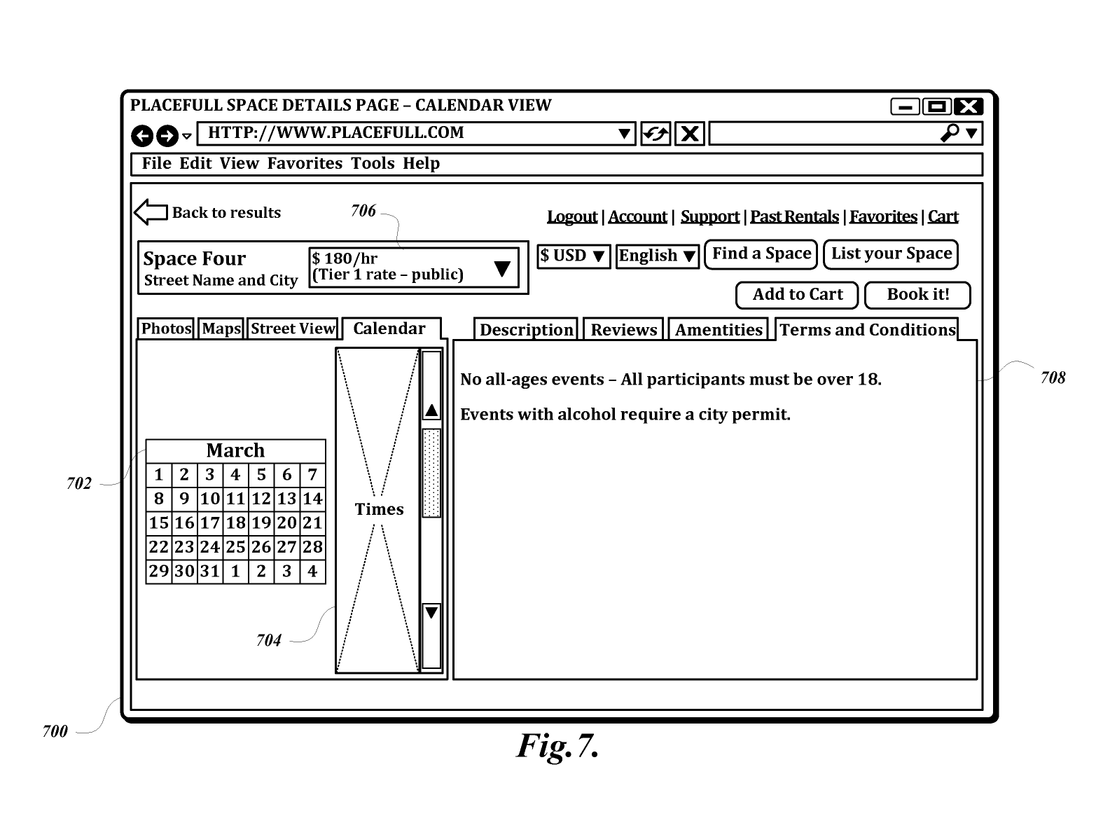

FIG. 7 illustrates an exemplary embodiment of a space detail interface 700 for displaying further details related to a selected space, according to various aspects of the present disclosure. The interface 700 may include a date interface 702 and a time interface 704. In embodiments wherein the space availability request was submitted along with the original query, the date and time of the space availability request may be automatically selected within the date interface 702 and the time interface 704. In embodiments wherein the space availability request was not submitted along with the original query, the date interface 702 and the time interface 704 may be used to submit such a request. The interface 702 may include a rate list 706 displaying one or more rates for renting the space. The rates displayed in the rate list 706 may be all rates available for the space, or may be limited to rates that the space management system 200 has determined are available to the end user 230 who submitted the query. The interface 700 may also include further details about the space, such as the illustrated tabbed interface which includes several categories of information. The tabbed interface may include terms and conditions 708 that are configurable by the space provider 202 based on a type of activity, a user group, and/or any other suitable categorization of use.

Returning now to FIG. 4A, the method 400 proceeds to a decision block 410, where a test is performed to determine whether the rental request is accepted. In some embodiments, the acceptance may be provided by an approving user. In some embodiments, the acceptance may be automatically granted once it is determined by the space management system 200 that the space is available at the requested time for the requested activity. If the answer to the test at decision block 410 is NO, the method 400 returns to terminal A, and a new selection is received from the end user 230. If the answer to the test at decision block 410 is YES, the method 400 proceeds to a continuation terminal (“terminal B”).

From terminal B (FIG. 4B), the method 400 proceeds to block 412, where the scheduling engine 214 stores a record in the scheduling data store 220 indicating the end user 230 has booked the space for the selected activity. The record may include time entries for the pre-activity services and the post-activity services indicating that the space is booked during those times as well. At block 414, a notification engine generates an alert to the space provider 202 for notifying the space provider 202 of the booking. As discussed above, the notification may be an email, a text message, or any other suitable notification.

At block 416, the end user interface engine 210 queries a service data store 222 and presents a set of service providers 204 available for the activity at the space. In some embodiments, the set of service providers 204 may be any service providers 204 that provide services relevant to the activity. In some embodiments, the set of service providers 204 may be limited to one or more service providers 204 specified by the space provider 202 as being authorized to provide services at the space. Once the end user 230 selects service providers for each service needed, the scheduling engine 214 updates the record in the scheduling data store 220 to indicate the set of service providers selected by the end user 230. At block 420, the notification engine 226 generates alerts to the selected service providers 204 for notifying the service providers 204 of the booking of their respective services, similar to the notifications transmitted to the space providers 202.

At block 422, a billing engine 228 determines an amount to be charged to the end user 230 for the booking, and fulfills the payment using one or more payment providers 232. The amount to be charged may be based on the rental rate of the space for the selected activity, and may be based on a renter category of the end user 230. In some embodiments, the amount to be charged may also include fees charged by the selected service providers 204 for the services to be performed. In some embodiments, the billing engine 228 may instruction a payment provider 232 associated with the end user 230 to transfer funds to one or more accounts, such as accounts associated with the space provider 202, the service providers 204, the space management system 200, and/or the like. In some embodiments, the billing engine 228 may enable barter for space rentals. In such embodiments, the billing engine 228 may credit an account associated with the space provider 202 a certain amount of credit, which may then be used by the space provider 202 to compensate the end user 230 when the space provider 202 (acting as an end user 230) is booking a space provided by the end user 230 (acting as a space provider 202). The method 400 then proceeds to an end block and terminates.

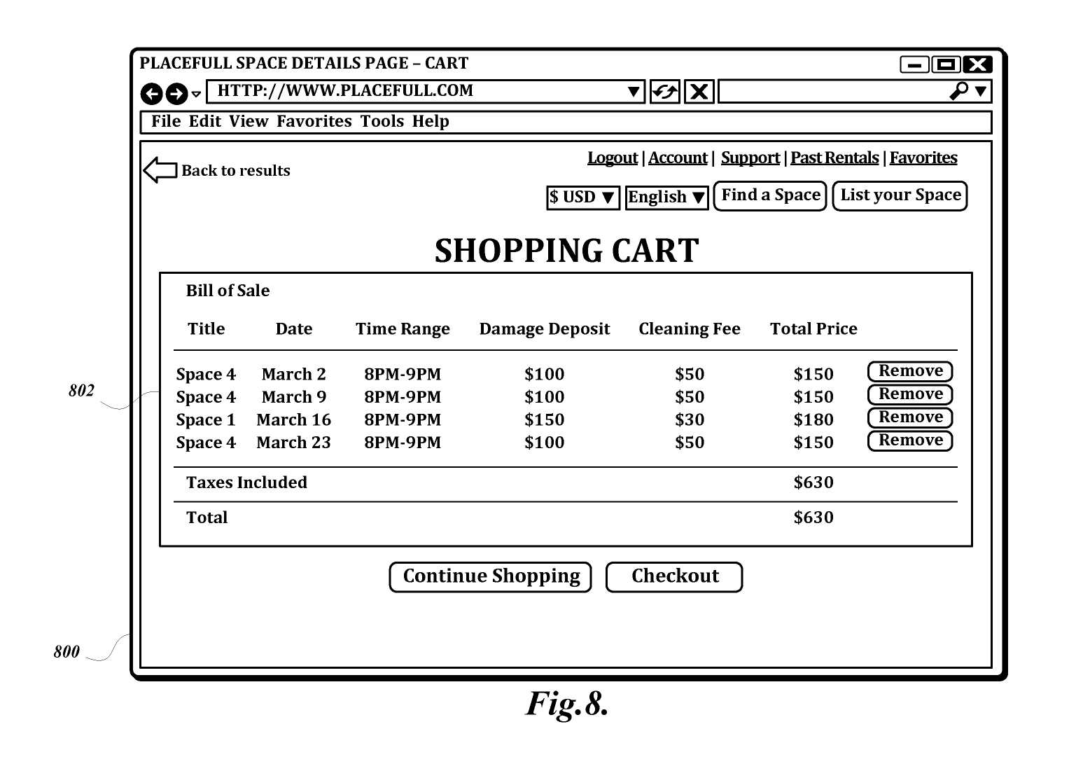

In some embodiments, selection of a space at a given date and time may cause the space rental to be added to a shopping cart before the reservation request is submitted for approval and/or payment. FIG. 8 illustrates an exemplary embodiment of a shopping cart interface 800 according to various aspects of the present disclosure. The interface 800 may include a list of space reservations 802 that have not yet been completed. As shown, the list of space reservations 802 show that the end user 230 is reserving a space one day a week for four straight weeks. Space 4 may not have been available for the third week, so the end user 230 or the space management system 200 may have chosen to replace Space 4 with Space 1 on the third week to complete the schedule. One of ordinary skill in the art will recognize that the use of a shopping cart interface may advantageously help the end user 230 to piece together multiple space reservations until an acceptable schedule is obtained, among other advantages.

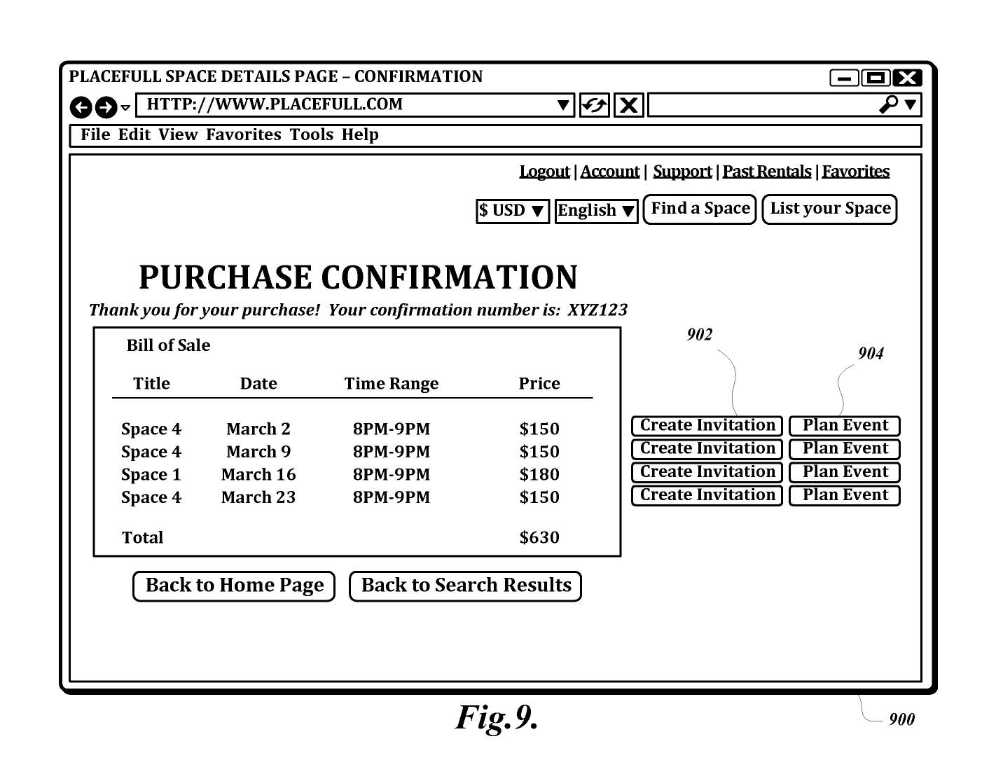

FIG. 9 illustrates an exemplary embodiment of a purchase confirmation interface 900 generated according to various aspects of the present disclosure. Along with a receipt and confirmation code for the group of reservations made, the interface 900 may include one or more create invitation interface buttons 902 and/or plan event interface buttons 904. Actuating these interface buttons may cause the space management system 200 to provide access to one or more external information services 236 or external notification services 234 to provide additional functionality related to the space reservations to the end user 230.

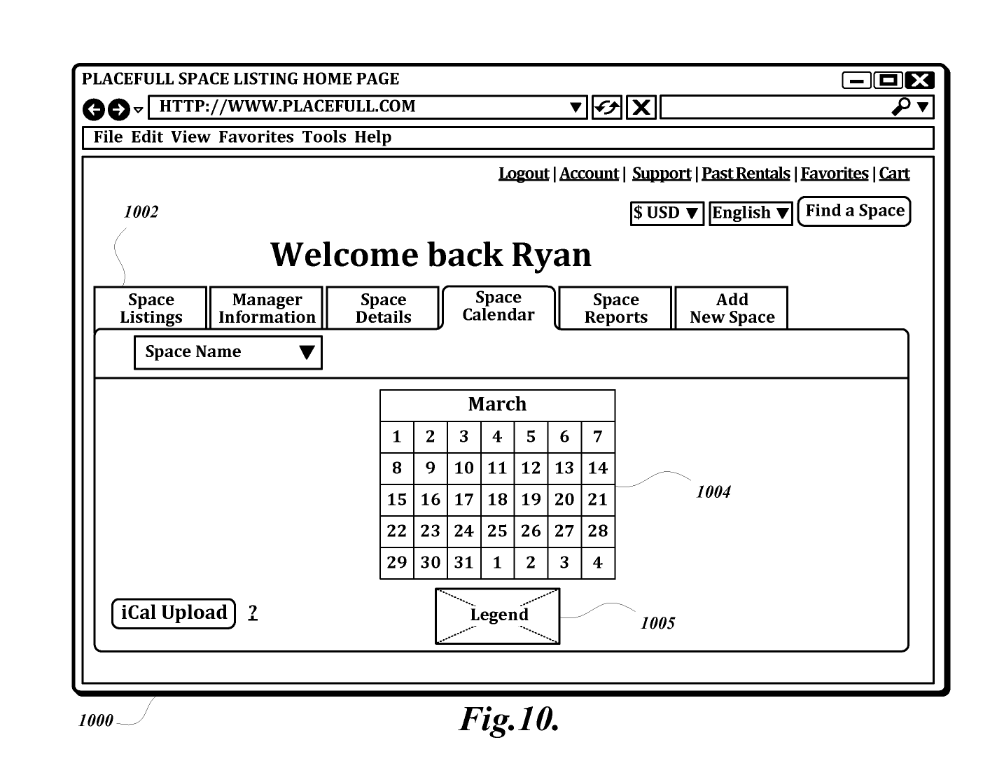

FIG. 10 illustrates an exemplary embodiment of a space management home interface 1000 generated by the provider interface engine 206 according to various aspects of the present disclosure. The interface 1000 may allow a space provider 202 to manage any aspect of the information stored by the space management system 200 associated with the spaces of the space provider 202. A tabbed interface 1002 may allow the space provider 202 to switch between different types of displayed information. As illustrated, space calendar information is displayed, including a calendar grid 1004 and a legend 1005. The legend 1005 may display various colors or other formats by which the calendar grid 1004 may indicate dates and/or times when the space is available, partially booked, fully booked, and/or the like. Upon selecting one of the other tabs of the tabbed interface 1002, information related to the selected tab may be displayed.

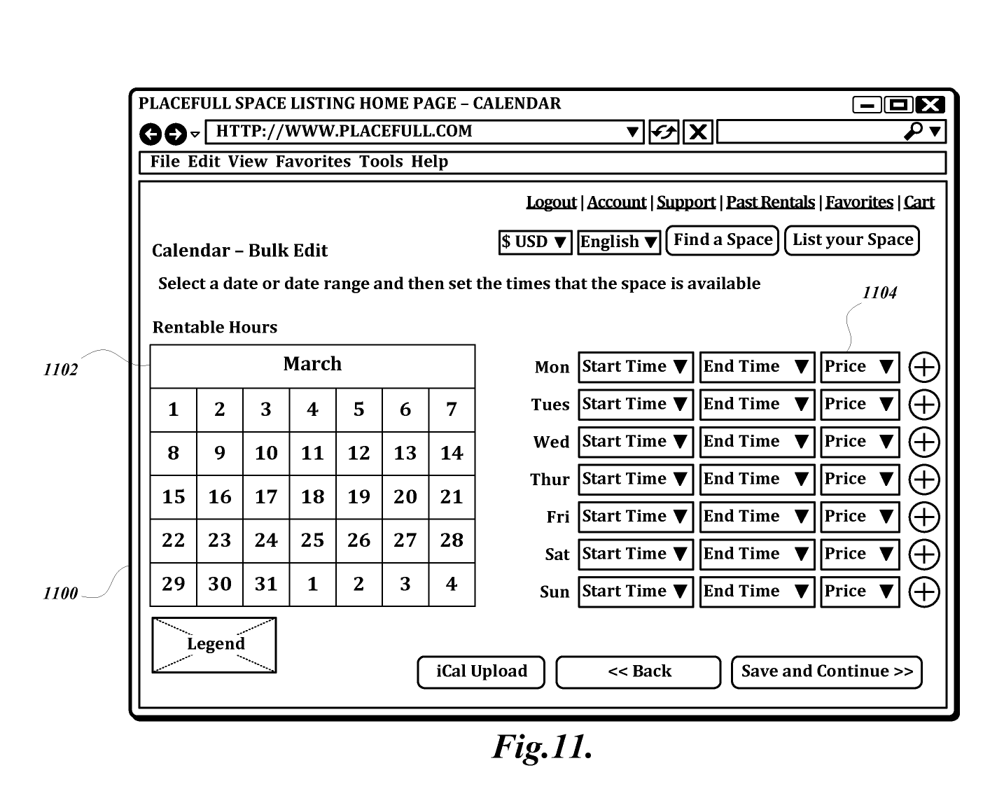

FIG. 11 illustrates an exemplary embodiment of a calendar bulk edit interface 1100 generated by the provider interface engine 206 according to various aspects of the present disclosure. The calendar bulk edit interface 1100 may allow the space provider 202 to specify one or more ranges during which the space is available or unavailable for rentals. For example, if a space provider 202 wishes to specify that a space is available from 9:00 AM to 5:00 PM on weekdays, the calendar bulk edit interface 1100 may be used to specify this availability. In some embodiments, the interface 1100 may include a price field 1104 by which a space provider 202 may indicate different prices on different days and/or at different times. For example, a space provider 202 may wish to set a higher price for weekends or other days of particularly high demand, compared to weekdays or other days of particularly low demand.

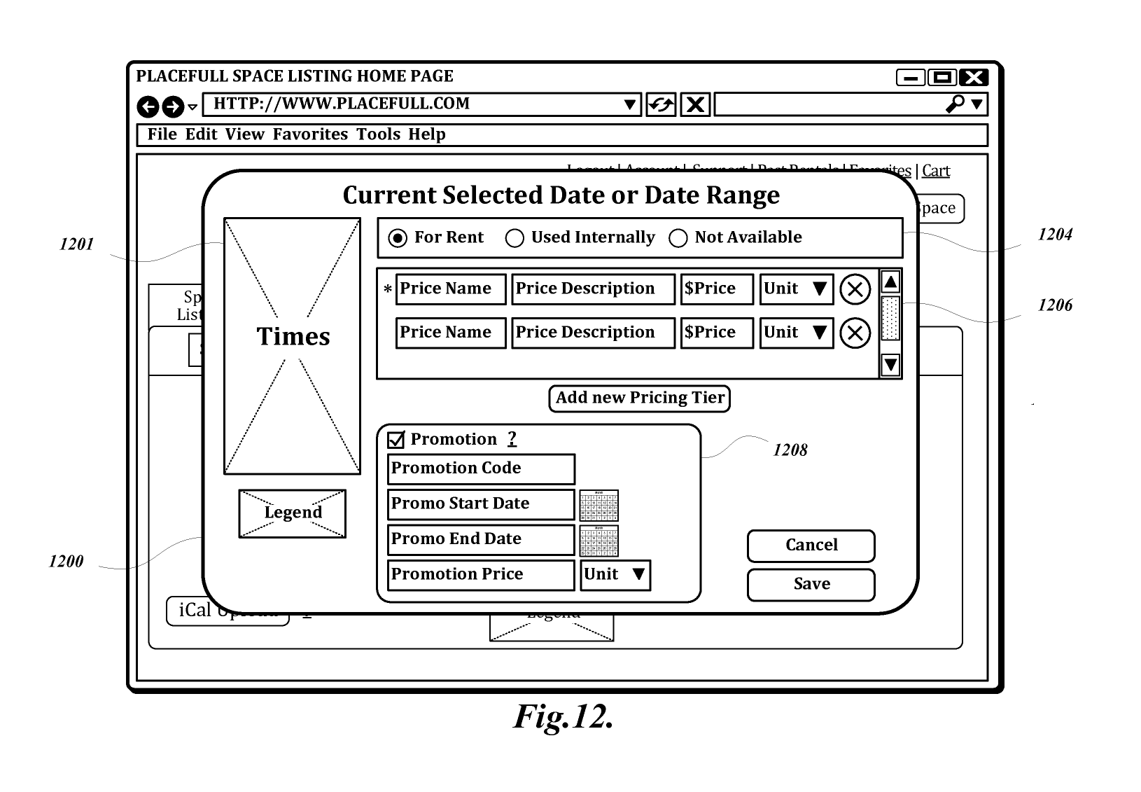

FIG. 12 illustrates an exemplary embodiment of a space management interface 1200 generated by the provider interface engine 206, according to various aspects of the present disclosure. In some embodiments, the space management interface 1200 may be presented upon selection of a day in an interface such as the space management home interface 1000 illustrated in FIG. 10 and described above. The space management interface 1200 may include a list of one or more time slots 1201. Upon selecting one or more time slots from the list of time slots 1201, the space provider 202 may change an availability associated with the one or more time slots by selecting a different value in an availability selection area 1204. The space provider 202 may also assign one or more pricing tiers to the one or more time slots, as indicated in the pricing tier list 1206, and may create a promotion (such as a discount, a special combination package, and/or the like) via a promotion creation area 1208.

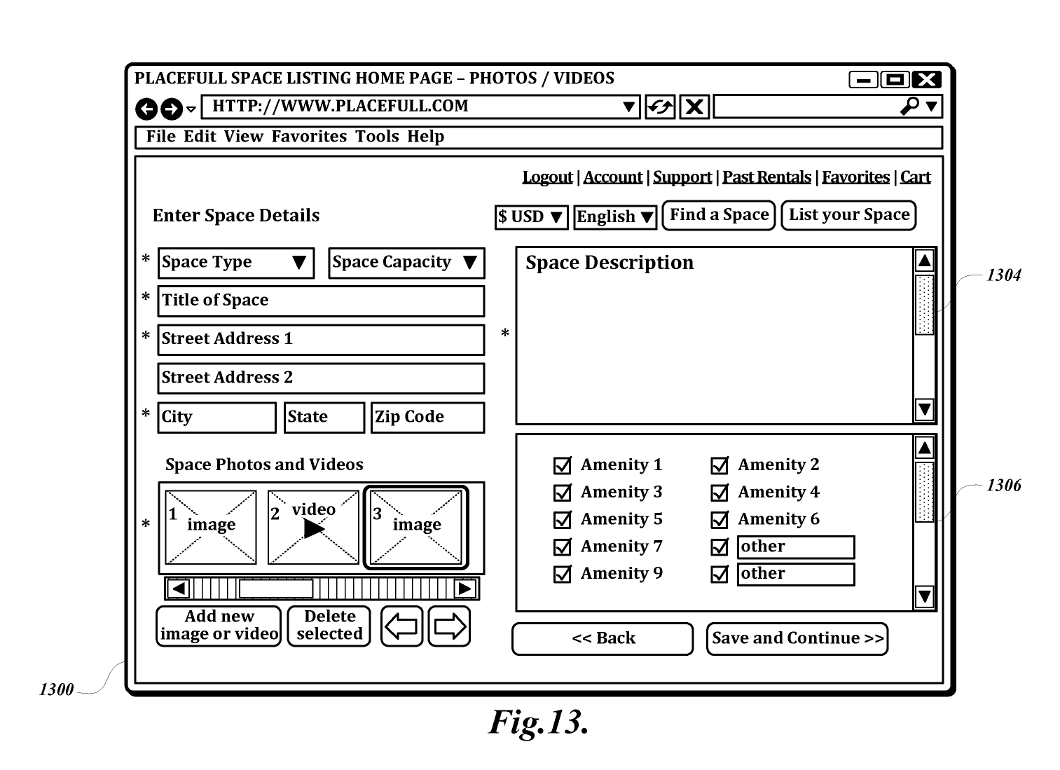

FIG. 13 illustrates an exemplary space detail management interface 1300 according to various aspects of the present disclosure. Upon adding a new space to the space management system 200, the interface 1300 may be presented to allow the space provider 202 to add information associated with the new space. A similar interface may be presented for editing information associated with a space already stored in the space management system 200. The interface 1300 may allow the space provider 202 to add various types of information, such as an address, photos, videos, a description 1304, one or more available amenities 1306, and/or the like. Each of the types of information added may be used during search queries to find the space, to compare the space to other spaces having similar amenities or locations, and/or the like.

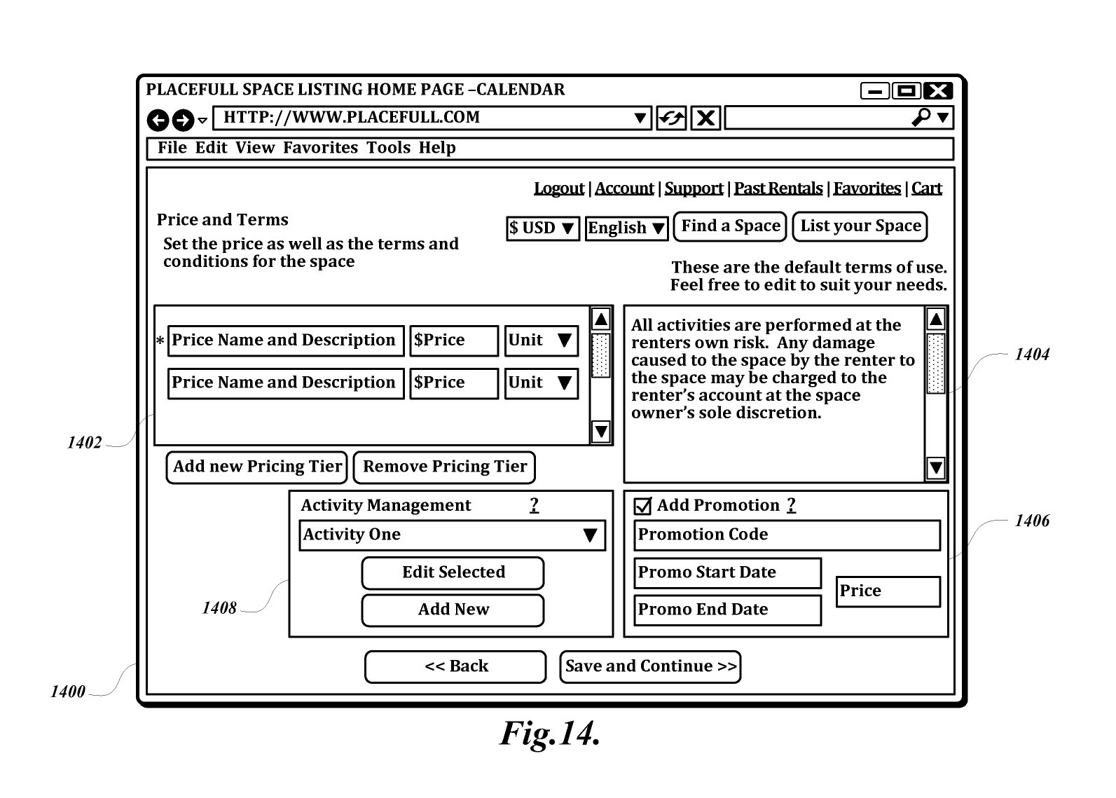

FIG. 14 illustrates an exemplary embodiment of a space detail management interface 1400 configured to allow a space provider 202 to manage further information associated with a space according to various aspects of the present disclosure. A pricing tier area 1402 may allow the space provider to add, remove, or modify pricing tiers available for the space. In some embodiments, such pricing tiers may be available unless overridden by information for a particular date or time, such as those described above with respect to FIG. 12. An activity interface area 1408 may allow the space provider 202 to select one or more activities for which the space is available. A drop-down list or other similar control may allow the space provider 202 to select an activity already present in the space management system 200. The activity interface control 1408 may also allow the space provider 202 to specify a new type of activity not yet present in the space management system 200. A promotion interface area 1406 may allow the space provider 202 to create one or more promotions that may provide a different price for renting the space during the specified time period. A terms of use interface area 1404 may allow the space provider 202 to edit the terms of use for the space. In some embodiments, the terms of use interface area 1404 may allow the space provider 202 to specify more than one set of terms of use, such as separate terms of use for different pricing tiers, different user groups, different activities, and/or the like.

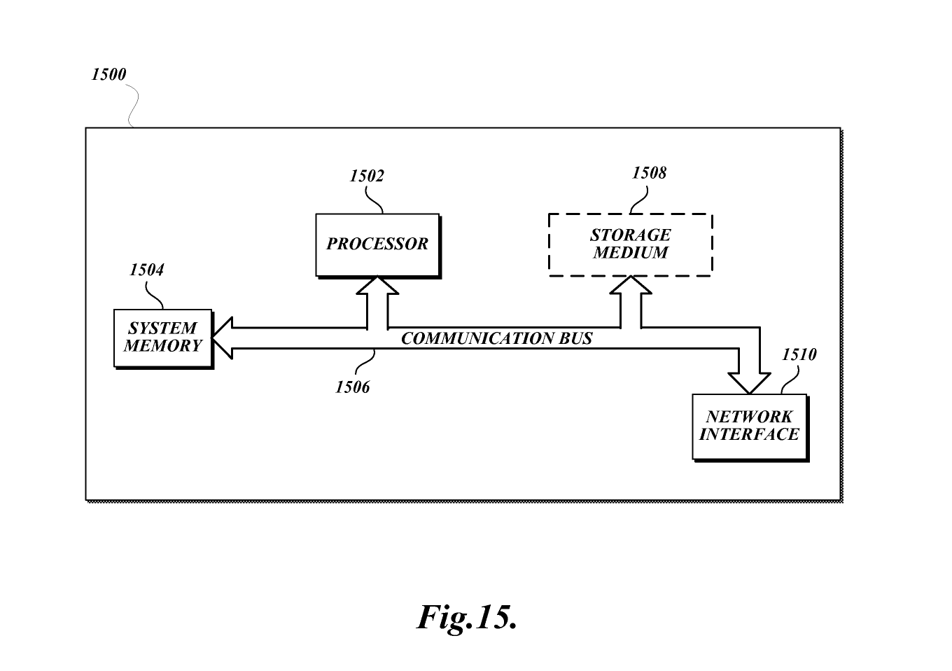

FIG. 15 illustrates aspects of an exemplary computing device 1500 appropriate for use with embodiments of the present disclosure. While FIG. 15 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 1500 may be any one of any number of currently available or yet to be developed devices.

In its most basic configuration, the computing device 1500 includes at least one processor 1502 and a system memory 1504 connected by a communication bus 1506. Depending on the exact configuration and type of device, the system memory 1504 may be volatile or nonvolatile memory, such as read only memory (“ROM”), random access memory (“RAM”), EEPROM, flash memory, or similar memory technology. Those of ordinary skill in the art and others will recognize that system memory 1504 typically stores data and/or program modules that are immediately accessible to and/or currently being operated on by the processor 1502. In this regard, the processor 1502 may serve as a computational center of the computing device 1500 by supporting the execution of instructions.

As further illustrated in FIG. 15, the computing device 1500 may include a network interface 1510 comprising one or more components for communicating with other devices over a network. Embodiments of the present disclosure may access basic services that utilize the network interface 1510 to perform communications using common network protocols. The network interface 1510 may also include a wireless network interface configured to communicate via one or more wireless communication protocols, such as WiFi, 2G, 3G, LTE, WiMAX, Bluetooth, and/or the like.

In the exemplary embodiment depicted in FIG. 15, the computing device 1500 also includes a storage medium 1508. However, services may be accessed using a computing device that does not include means for persisting data to a local storage medium. Therefore, the storage medium 1508 depicted in FIG. 15 is represented with a dashed line to indicate that the storage medium 1508 is optional. In any event, the storage medium 1508 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 1504 and storage medium 1508 depicted in FIG. 15 are merely examples of computer-readable media.

Suitable implementations of computing devices that include a processor 1502, system memory 1504, communication bus 1506, storage medium 1508, and network interface 1510 are known and commercially available. For ease of illustration and because it is not important for an understanding of the claimed subject matter, FIG. 15 does not show some of the typical components of many computing devices. In this regard, the computing device 1500 may include input devices, such as a keyboard, keypad, mouse, microphone, touch input device, touch screen, tablet, and/or the like. Such input devices may be coupled to the computing device 1500 by wired or wireless connections including RF, infrared, serial, parallel, Bluetooth, USB, or other suitable connections protocols using wireless or physical connections. Similarly, the computing device 1500 may also include output devices such as a display, speakers, printer, etc. Since these devices are well known in the art, they are not illustrated or described further herein.

As will be appreciated by one of ordinary skill in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

As will also be appreciated by one of ordinary skill in the art, the specific interface drawings illustrated and described herein, including FIGS. 5, 6, 7, 8, 9, 10, 11, 12, 13, and 14, are exemplary only, and should not be construed as limiting. For example, in some embodiments, interfaces may be presented that include more or less features than those illustrated in the above features, or that provide functionality described in the text herein that is not included in an interface drawing. For such functionality, applicants respectfully submit that the design and implementation of an interface to provide such functionality will be within the capability of one of ordinary skill in the art based on the description provided herein. Further, only some features of FIGS. 5, 6, 7, 8, 9, 10, 11, 12, 13, and 14 were described in the text, for the sake of brevity. The purpose, functionality, and implementation of the features not explicitly described herein will be recognized by one of ordinary skill in the art given the rest of the disclosure provided herein.

While illustrative embodiments have been illustrated and described, it will be appreciated that various changes can be made therein without departing from the spirit and scope of the claimed subject matter.

1. A non-transitory computer-readable medium having computer-executable instructions stored thereon that, in response to execution by one or more processors of a computing device, cause the computing device to perform actions for scheduling space rentals, the actions comprising:
in response to receiving a request from an end user to reserve a space during a first time period:
determining an amount to be charged to the end user for reserving the selected space;
using one or more payment providers to fulfill a payment from the end user of the determined amount; and
creating a first record indicating that the space has been reserved by the end user during the first time period; and
in response to receiving a request from an administrative user to reserve the space during a second time period:
creating a second record indicating that the space is reserved by the administrative user during the second time period;
wherein the second record is created without fulfilling a payment from the administrative user.

2. The non-transitory computer-readable medium of claim 1, wherein the request from the end user is received via an end user interface, and wherein the request from the administrative user is received via an administrative interface separate from the end user interface.

3. The non-transitory computer-readable medium of claim 1, wherein the actions further comprise, in response to receiving a second request from an end user to reserve a space during a third time period:
determining whether the space is available during the third time period; and
presenting an indication to the end user that the space is not available in response to a determination that the space is not available during the third time period.

4. The non-transitory computer-readable medium of claim 3, wherein the second request from the end user includes an indication of an activity to be performed during the third time period.

5. The non-transitory computer-readable medium of claim 4, wherein the activity includes at least one of a pre-activity service to take place before the third time period and a post-activity service to take place after the third time period, and
wherein determining whether the space is available during the third time period includes determining whether the space is reserved during the pre-activity service or the post-activity service.

6. The non-transitory computer-readable medium of claim 4, wherein the activity is a high-impact activity, and wherein determining whether the space is available during the third time period includes determining whether another high-impact activity is scheduled within a predetermined period of time before or after the third time period.

7. The non-transitory computer-readable medium of claim 1, wherein the request from the administrative user includes an indication of an activity to be performed during the second time period.

8. A computer-implemented method of scheduling space rentals, the method comprising:
in response to receiving, by a computing device, a request from an end user to reserve a space during a first time period:
determining, by the computing device, an amount to be charged to the end user for reserving the selected space;
using one or more payment providers to fulfill a payment from the end user of the determined amount; and
creating, by the computing device, a first record indicating that the space has been reserved by the end user during the first time period; and
in response to receiving, by the computing device, a request from an administrative user to reserve the space during a second time period:
creating, by the computing device, a second record indicating that the space is reserved by the administrative user during the second time period;
wherein the second record is created without fulfilling a payment from the administrative user.

9. The method of claim 8, wherein the request from the end user is received via an end user interface, and wherein the request from the administrative user is received via an administrative interface separate from the end user interface.

10. The method of claim 8, further comprising, in response to receiving a second request from an end user to reserve a space during a third time period:
determining whether the space is available during the third time period; and
presenting an indication to the end user that the space is not available in response to a determination that the space is not available during the third time period.

11. The method of claim 10, wherein the second request from the end user includes an indication of an activity to be performed during the third time period.

12. The method of claim 11, wherein the activity includes at least one of a pre-activity service to take place before the third time period and a post-activity service to take place after the third time period, and
wherein determining whether the space is available during the third time period includes determining whether the space is reserved during the pre-activity service or the post-activity service.

13. The method of claim 11, wherein the activity is a high-impact activity, and wherein determining whether the space is available during the third time period includes determining whether another high-impact activity is scheduled within a predetermined time period before or after the third time period.

14. The method of claim 8, wherein the request from the administrative user includes an indication of an activity to be performed during the second time period.

15. A computing system, comprising:
at least one processor; and
a computer-readable medium;
wherein the computer-readable medium has computer-executable instructions stored thereon that, in response to execution by the at least one processor, cause the computing system to perform actions for scheduling space rentals, the actions comprising:
in response to receiving a request from an end user to reserve a space during a first time period:
determining an amount to be charged to the end user for reserving the selected space;
using one or more payment providers to fulfill a payment from the end user of the determined amount; and
creating a first record indicating that the space has been reserved by the end user during the first time period; and
in response to receiving a request from an administrative user to reserve the space during a second time period:
creating a second record indicating that the space is reserved by the administrative user during the second time period;
wherein the second record is created without fulfilling a payment from the administrative user.

16. The system of claim 15, wherein the request from the end user is received via an end user interface, and wherein the request from the administrative user is received via an administrative interface separate from the end user interface.

17. The system of claim 15, wherein the actions further comprise, in response to receiving a second request from an end user to reserve a space during a third time period:
determining whether the space is available during the third time period; and
presenting an indication to the end user that the space is not available in response to a determination that the space is not available during the third time period.

18. The system of claim 17, wherein the second request from the end user includes an indication of an activity to be performed during the third time period.

19. The system of claim 18, wherein the activity includes at least one of a pre-activity service to take place before the third time period and a post-activity service to take place after the third time period, and
wherein determining whether the space is available during the third time period includes determining whether the space is reserved during the pre-activity service or the post-activity service.

20. The system of claim 18, wherein the activity is a high-impact activity, and wherein determining whether the space is available during the third time period includes determining whether another high-impact activity is scheduled within a predetermined period of time before or after the third time period.
